(19) United States
(12) Patent Application Publication
(10) Pub. No.: US 2013/0298864 A1
(43) Pub. Date: Nov. 14, 2013

(54) COVERING DEVICE FOR A SPARK PLUG SHAFT AND OPTICAL FIBER DEVICE FOR A LASER SPARK PLUG

(71) Applicants: Karl-Heinz Nuebel, Simmozheim (DE); Manfred Vogel, Ditzingen (DE); Frank Barth, Tamm (DE); Martin Weinrotter, Vitoria-Gasteiz (ES)

(72) Inventors: Karl-Heinz Nuebel, Simmozheim (DE); Manfred Vogel, Ditzingen (DE); Frank Barth, Tamm (DE); Martin Weinrotter, Vitoria-Gasteiz (ES)

(73) Assignee: ROBERT BOSCH GmbH, Stuttgart (DE)

(21) Appl. No.: 13/885,297

(22) PCT Filed: Sep. 13, 2011
(86) PCT No.: PCT/EP2011/065814

§ 371 Date: Jul. 30, 2013

(30) Foreign Application Priority Data
Nov. 15, 2010 (DE) 10 2010 043 890.1

(51) Int. Cl. H01T 13/06

(52) U.S. Cl. CPC H01T 13/06
USPC 123/143 C

(57) ABSTRACT

A covering device for a spark plug shaft of an internal combustion engine has a fastening element provided for mechanically fastening the covering device to a target system, the fastening element being configured to electrically conductively connect at least one electric conductor to the covering device (100) and/or the target system.

### BACKGROUND OF THE INVENTION

### Field of the Invention

The present invention relates to a covering device for a spark plug shaft of an internal combustion engine, in particular of a stationary heavy-duty gas engine. The present invention further relates to an optical fiber device for a laser spark plug.

### BRIEF SUMMARY OF THE INVENTION

It is an object of the present invention to improve a covering device and an optical fiber device of the type mentioned at the outset in such a way that an increased operational reliability of these components is provided.

In the covering device of the type according to the present invention stated at the outset, this object is achieved by providing the fastening means for mechanically fastening the covering device on a target system and by furthermore designing the fastening means in such a way that at least one electric conductor is electrically conductively connected to the covering device and/or to the target system. In this way, the design of an electrical measuring loop may be supported via the covering device which is, for example, used to check a proper installation of the covering device in a target system, such as a cylinder head of the internal combustion engine, for example.

Since a target system for the covering device in general has a fixed electric reference potential, such as a frame potential, the electric conductor, which is also an integral part of an electrical measuring loop, for example, may be advantageously connected to this reference potential via the fastening means according to the present invention. The electric conductor may, for example, be acted on by a correspondingly configured evaluation unit using voltage pulses against the reference potential, and a current flow, which may result due to the voltage pulses, via the electric conductor and the covering device or their fastening means to the reference potential, may be detected. From the current flow or an interruption of the current flow, it is advantageously possible to infer an operating state of the system, in particular an electrical connection between the electric conductor, the covering device, and the reference potential.

The fastening means of the covering device according to the present invention thus advantageously allow on the one hand the mechanical mounting of the covering device on the target system, and on the other hand the electric contacting of an electric reference potential corresponding to the target system.

In one preferred specific embodiment, the fastening means are designed to connect the at least one electric conductor to the covering device and/or to the target system with the aid of a screw connection or a clamping connection.

In one preferred specific embodiment, the fastening means have a mechanical coding which cooperates with a corresponding mechanical coding of a contact element of the conductor in such a way that only in the case of a proper mechanical fastening of the contact element at the fastening means is an electrically conductive connection at all establishable between the contact element and the covering device and/or the target system. In this way, it is advantageously avoided that an electrical contact, which could result in an incorrect electrical evaluation, is already established in the case of an improper mechanical mounting of the components. In particular, it is effectively prevented with the aid of the mechanical coding that a contact element, which lies loosely on the covering device or the cylinder head, already establishes an electrical contact with the reference potential.

In another preferred specific embodiment, the fastening means have, as the mechanical coding, an elevated eye which protrudes from a base area of the covering device and which may preferably cooperate with a corresponding mechanically coded ring cable lug of the electric conductor.

In another preferred specific embodiment, the fastening means have a screw or a stud bolt and a nut cooperating with the stud bolt.

In another preferred specific embodiment, the covering device is impermeable to optical radiation of at least one predefined wavelength range, whereby the exit of laser radiation from a plug shaft into the surroundings is prevented.

Particularly preferably, the covering device is made at least partially of plastic and/or metal and/or a magnetically conductive material, in particular ferrite material.

In another preferred specific embodiment, at least one identifier is provided which is preferably designed as a radio frequency identification (RFID) transponder and which is designed to wirelessly transmit an identification signal to an evaluation unit which applies a query signal to the identifier, whereby a wireless check of the covering device may be carried out with the aid of a corresponding evaluation unit. In addition to a pure recognition of whether the covering device is present, a type code of the covering device included in the identification signal, etc., may also be checked here.

The object of the present invention is furthermore achieved by an optical fiber device for a laser spark plug, which optical fiber device has at least one optical fiber for transmitting optical power to the laser spark plug and at least one electric signal conductor for transmitting electrical signals. The signal conductor may advantageously be used to implement the measuring loop already described previously and thus also allows, among other things, the integrity of the optical fiber device to be monitored.

In one preferred specific embodiment, an end section of the signal conductor has a contact element, in particular a ring cable lug, for electrically contacting an object, in particular the fastening means of the covering device according to the present invention.

In another preferred specific embodiment, the contact element has a mechanical coding, the mechanical coding being in particular compatible with the mechanical coding of the fastening means of the covering device according to the present invention.

In another preferred specific embodiment, the signal conductor is at least sectionally wound, preferably in a spiral-shaped manner, around a carrier layer of the optical fiber device, whereby a wear through of the optical fiber device is advantageously recognizable, as it may occur on a sharp-edged object, for example.

Alternatively or additionally, the signal conductor may be formed at least sectionally by resistance paths which are situated, in particular printed, on the carrier layer of the optical fiber device and which preferably essentially extend in the longitudinal direction of the optical fiber device.

Alternatively or additionally, the signal conductor may be knitted at least partially in a net-like manner to form a conductive hose.

The object of the present invention is also achieved by an ignition system which includes the following: a laser spark plug, a pumping module for supplying the laser spark plug with pumped radiation, and an optical fiber device according to the present invention for transmitting the pumped radiation from the pumping module to the laser spark plug, an evaluation unit being provided which is designed to apply a check signal to at least one signal conductor of the optical fiber device, to evaluate a response signal resulting from the particular check signal, and to infer an operating state of the signal conductor from the response signal.

### BRIEF DESCRIPTION OF THE DRAWINGS

FIG. 1 schematically shows a partial cross section of a cylinder head of an internal combustion engine having a covering device according to one first specific embodiment of the present invention.

FIG. 2 schematically shows a perspective illustration of a covering device according to another specific embodiment.

FIGS. 3 through 5 each schematically show one specific embodiment of an optical fiber device according to the present invention.

FIG. 6 schematically shows an ignition system according to the present invention.

### DETAILED DESCRIPTION OF THE INVENTION

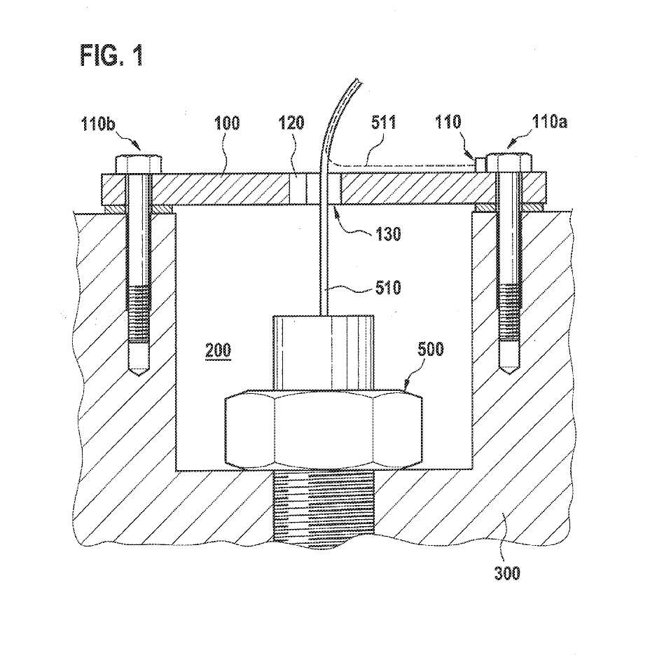

FIG. 1 shows a partial cross section of a cylinder head 300 of an internal combustion engine which may be a stationary heavy-duty gas engine or also an internal combustion engine of a motor vehicle, for example. A spark plug 500, which is designed in the present case as a laser spark plug, for example, and which may be supplied with electrical and/or optical power by a remotely situated control unit (not shown) via a cable 510, is situated in a spark plug shaft 200 provided in cylinder head 300.

To prevent spark plug 500 from shooting out of cylinder head 300, a covering device 100 which is approximately disc-shaped in the present case and which may be fastened to cylinder head 300 via fastening means 110 having screws 110a, 110b, for example, is situated in FIG. 1 above spark plug shaft 200.

Covering device 100 has an opening 130 for cable 510 to be guided through. In the present case, opening 130 is slit-shaped so that cable 510 may be introduced laterally into covering device 100. Alternatively, opening 130 may also be designed as a bore hole.

Optionally, covering device 100 may also have at least one identifier 120 which is designed to wirelessly transmit an identification signal to an evaluation unit (not shown) which applies a query signal to identifier 120. In this way, the evaluation unit may determine the presence of covering device 100 and, if necessary, its construction type, etc., and, for example, activate or prevent an activation of laser spark plug 500 as a function thereof.

According to the present invention, fastening means 110 are furthermore designed to electrically conductively connect at least one electric conductor 511 to covering device 100 and/or cylinder head 300. Electric conductor 511 may, for example, be an integral part of a measuring loop, with the aid of which it is established whether electric conductor 511 is connected to a reference potential. In the present case, electric conductor 511 is electrically conductively connected to covering device 100 and cylinder head 300 via fastening means 110 according to the present invention of covering device 100. This is achieved, for example, with the aid of a clamping and/or screw connection between conductor 511 and covering device 100.

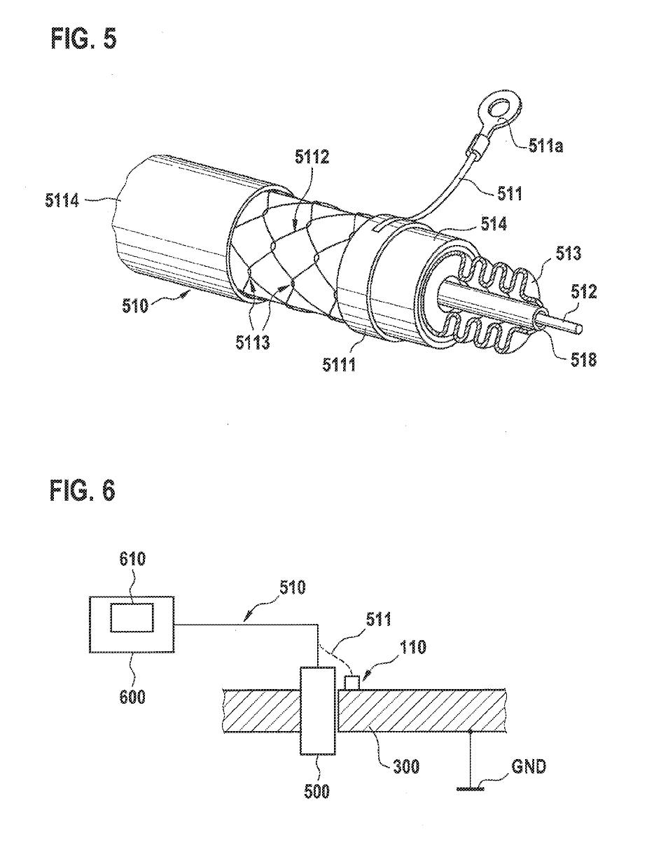

FIG. 6 schematically shows an ignition system for an internal combustion engine having laser spark plug 500 according to FIG. 1 in its installation position in cylinder head 300 which lies on an electric reference potential, presently on frame potential GND.

A pumping module 600 is used to generate pumped radiation for optically pumping components of laser spark plug 500. The pumped radiation is guided from pumping module 600 to laser spark plug 500 via an optical fiber device 510 having at least one optical fiber. In addition to the optical fiber, optical fiber device 510 also has at least one electric signal conductor 511 which may be used to monitor the integrity of optical fiber device 510. For this purpose, the end area of electric signal conductor 511, which faces laser spark plug 500, is electrically connected to reference potential GND of cylinder head 300, which may advantageously take place using fastening means 110 of covering device 100 according to the present invention (FIG. 1). Essentially disc-shaped covering device 100 itself is not shown in FIG. 6 for the sake of clarity.

An evaluation unit 610, which is integrated into pumping module 600 in the present case, is designed to apply a check signal, such as a voltage pulse, to the at least one signal conductor 511 of optical fiber device 510, to evaluate a response signal, in particular a current flow through signal conductor 511, resulting from the particular check signal, and to infer an operating state of signal conductor 511 from the response signal.

If signal conductor 511 is, for example, properly connected to frame potential GND of cylinder head 300, corresponding current pulses will result through signal conductor 511 as a consequence of the voltage pulses. Otherwise, corresponding current pulses are not detectable by evaluation unit 610 and it is inferred that either the connection between signal conductor 511 and frame potential GND is interrupted, e.g., because signal conductor 511 is not properly fastened, or that optical fiber device 510 together with signal conductor 511 is interrupted in general. In this case, evaluation unit 610 initiates a deactivation of the ignition system, in particular of pumping module 600, to prevent pumped radiation from exiting into the surroundings through possibly damaged optical fiber device 510.

Although the ignition system according to FIG. 6 preferably uses fastening means 110 of covering device 100 according to the present invention (FIG. 1) to connect signal conductor 511 to frame potential GND, the ignition system according to the present invention may also be operated without a covering device 100 according to the present invention with the aid of the check by evaluation unit 610. In this case, the electrical connection between signal conductor 511 and frame potential GND is to be established in a different manner for the check by evaluation unit 610, e.g., through separate fastening means (not shown) in the area of cylinder head 300.

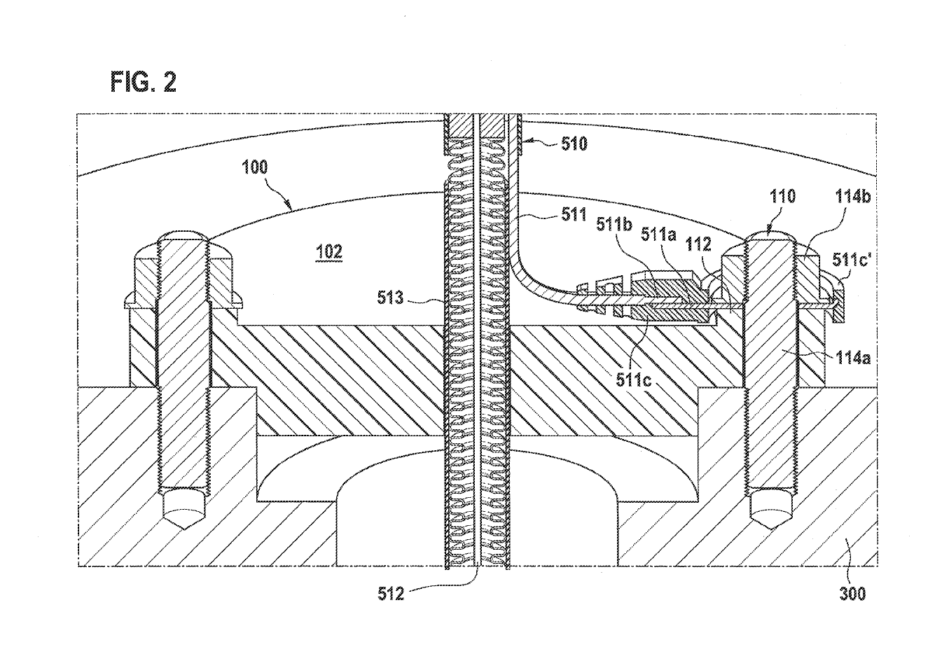

FIG. 2 schematically shows a perspective illustration of a covering device 100 according to another specific embodiment. In the present case, covering device 100 is fixed to cylinder head 300 by fastening means 110. Fastening means 110 have, among other things, stud bolts 114a which are fastened in cylinder head 300 and protrude through the corresponding bore holes in covering device 100. Covering device 100 is screwed against cylinder head 300 with the aid of nuts 114b.

Optical fiber device 510 according to FIG. 2 has a metal hose 513 in which an optical fiber 512 is situated. Outside of metal hose 513, a signal conductor 511, which is electrically insulated therefrom, is guided in FIG. 2 starting from above to closely to a surface area 102 of covering device 100. Signal conductor 511, for example, is combined with metal hose 513 and another hose, which is not indicated in greater detail, to form optical fiber device 510.

In the area of surface 102 of covering device 100, signal conductor 511 is separated from the combination of optical fiber device 510, and an end area 511b of signal conductor 511 is electrically conductively connected via a clamping connection to a contact element 511a designed in the present case as a ring cable lug.

In the specific embodiment illustrated in FIG. 2, fastening means 110 advantageously have a mechanical coding which cooperates with a corresponding mechanical coding of contact element 511a of conductor 511 in such a way that only in the case of a proper mechanical fastening of contact element 511a at fastening means 110 is an electrically conductive connection at all establishable between contact element 511a and covering device 100 and/or cylinder head 300. In this way, it may be ensured that a check with the aid of a measuring loop including conductor 511 does not provide incorrect results, e.g., when contact element 511a only lies loosely on cylinder head 300.

In the present case, the mechanical coding of contact element 511a is implemented by being extrusion-coated by non-conductive plastic 511c. Among other things, the plastic forms a ring 511c′ which surrounds a metal ring of ring cable lug 511a in such a way that it is not able to establish an electrically conductive contact with an essentially planar surface 102, 300.

The mechanical coding of covering device 100 is presently implemented by an elevated eye 112 which protrudes from a base area 102 of covering device 100 and whose geometry is adapted to the shape of extrusion coated ring cable lug 511a, in particular of plastic ring 511c′. Only if plastic ring 511c′—as is apparent from FIG. 2—is situated coaxially above eye 112 and is screwed against eye 112 with the aid of nut 114b, is the electrical contact established between conductor 511 and cylinder head 300. Thus, the measuring loop including components 600, 511, 511a, 112, 114a, 300 which starts at evaluation unit 610 and ends with frame potential GND of the cylinder head is completed and evaluation unit 610 may evaluate this operating state with the aid of the measuring loop. For example, evaluation unit 610 may only actively switch pumping module 600 if the evaluation of the measuring loop resulted in a proper contact of conductor 511 to frame potential GND.

In another preferred specific embodiment, covering device 100 is impermeable to optical radiation of at least one predefined wavelength range, whereby the exit of laser radiation from plug shaft 200 (FIG. 1) into the surroundings is prevented.

According to another preferred specific embodiment, covering device 100 is particularly preferably made at least partially of plastic and/or metal and/or a magnetically conductive material, in particular ferrite material. When covering device 100 is designed to be electrically conductive itself, the electrical connection between conductor 511 and cylinder head 300 may also take place via covering device 100 alone and not necessarily via fastening means 110 and 114a (FIG. 2) themselves. For example, fastening means 110 may be designed to establish an electrically conductive contact between conductor 511 or its contact element 511a and surface 102 of covering device 100, and an area of covering device 100, which lies outside of fastening means 110, establishes the additional electrical connection to cylinder head 300.

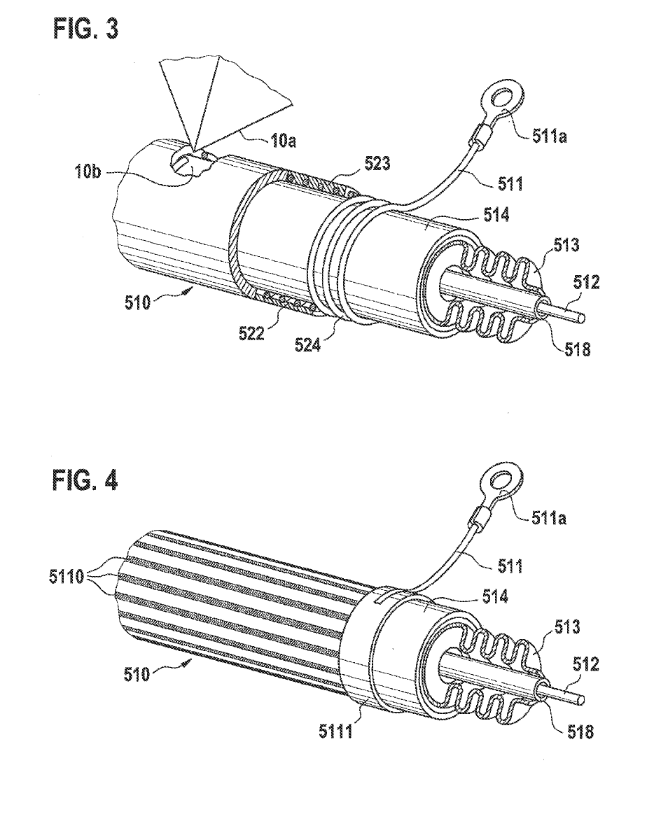

FIGS. 3, 4, 5 described in the following show other advantageous specific embodiments of an optical fiber device 510 according to the present invention which, in addition to at least one optical fiber 512, which is used for transmitting pumped radiation to laser spark plug 500 (FIG. 1), for example, also have a metal hose 513, which shields optical fiber 512 against the surroundings. In this way, it is avoided, in particular, that pumped radiation exits from optical fiber device 510 into the surroundings in the case of a fiber fracture of optical fiber 512. Furthermore, a mechanical protection of optical fiber 512 also results due to metal hose 513.

An inner protection hose 518, which protects optical fiber 512 against wear due to internal friction against metallic external hose 513, for example, may be advantageously provided between metal hose 513 and optical fiber 512. If inner protection hose 518 is designed to be lightproof for the guided laser radiation, it advantageously forms an additional barrier against an undesirable exit of the pumped radiation.

In all three specific embodiments according to FIGS. 3, 4, 5, the end of signal conductor 511, which is electrically insulated against metal hose 513, has a ring cable lug, e.g., according to FIG. 2. Other contact elements are also usable.

In optical fiber device 510 according to FIG. 3, signal conductor 511 is at least sectionally wound, preferably in a spiral-shaped manner, around a carrier layer 514 of optical fiber device 510.

The winding configuration of signal conductor 511 is fixed in the position on carrier layer 514, which may also be designed as a hose, with the aid of a shell 522 or an extrusion coating 523. Individual windings 524 of signal conductor 511, which is not insulated in the present case, may not touch each other in order to prevent an interwinding fault.

The previously described configuration of signal conductor 511 may also be advantageously used, in addition to the already described diagnostic principle according to the present invention, to detect a wear through of optical fiber device 510 or its shell 522, 523.

Namely, if a part of optical fiber device 510 rests against a part 10a of engine 10a during operation, for example, material 10b may be removed over time. This material removal 10b subsequently first interrupts signal conductor 511 and triggers a safety shutdown of pumping module 600—due to the monitoring by evaluation unit 610 with the aid of check signals—before a hole forms in inner layers 514, 513, 518 around optical fiber 512 itself and an endangerment arises due to laser light exiting into the surroundings.

Signal conductor 511 may also advantageously be designed as an enameled copper wire, for example, so that it is possible to dispense with an insulating carrier 514 or an electrically insulating design of the radially outer surface of metal hose 513.

When evaluating a check signal which is, for example, coupled into signal conductor 511 by evaluation unit 610, it must be taken into consideration that the components implementing the measuring loop may rest against a metallic engine part 10a which lies on frame potential GND of the engine. In this way, it would not be possible to differentiate a contact in the area of interruption 10b of conductor 511 from a proper electrical contact via cable lug 511a. It is, however, extremely unlikely due to the vibrations of the engine that this contact is always applied. This is why it is very likely that the error is detected in that evaluation unit 610 (FIG. 2) triggers (e.g., deactivates pumping module 600) in the case of the first interruption of the measuring loop or signal conductor 511 and leaves pumping module 600 deactivated even in the case of a subsequent reconnection to frame potential GND. The evaluation becomes even more precise when the electrical connection between evaluation unit 610 and frame potential GND is continuously monitored in the area of laser spark plug 500 at a sampling frequency which is greater compared to the expected vibration frequency of the system and which is more than double the vibration frequencies.

In another specific embodiment, the spiral of signal conductor 511 according to FIG. 3 is printed on hose 514 in the form of a conductive lacquer, for example, or embedded as a two-component part as a conductive plastic in the insulating plastic.

In another advantageous specific embodiment (cf. FIG. 4), signal conductor 511 is formed at least sectionally by resistance paths 5110 which are situated, in particular printed, on a carrier layer 514 of optical fiber device 510 and which preferably essentially extend in the longitudinal direction of optical fiber device 510.

According to one preferred specific embodiment, multiple or all resistance paths 5110 are switched electrically in parallel, which is achievable, for example, by metal rings 5111 on the pumping module side (not shown) and on the laser plug side (FIG. 4).

It is apparent from FIG. 4 that a metal ring 5111 which contacts resistance paths 5110 is connected to ring cable lug 511a via a short line segment of signal conductor 511. In this variant of the present invention, the evaluation by evaluation unit 610 (FIG. 2) provides that the resistance of resistance paths 5110 is measured. As soon as one of resistance paths 5110 wears through or is damaged or changed in any other manner, the resistance of the monitored measuring loop changes and pumping module 600 is switched off.

In one particularly preferred specific embodiment, the number of resistance paths 5110 and their distances from one another along a peripheral direction on carrier hose 514 is selected in such a way that on the one hand, a wear point 10b (FIG. 3) may be reliably detected by the evaluation according to the present invention. For example, a number of approximately 20 to approximately 100 resistance paths 5110 may be provided if hose 514 is approximately 10 mm in diameter.

On the other hand, the interruption of an individual resistance path 5110 should also still be reliably detectable when the resistance of the measuring loop is evaluated, i.e., evaluation unit 610 must be able to reliably detect a change of 1% of the resistance value in 100 resistance paths 5110, for example. Furthermore, this 1% change must be considerably greater than possible changes in the resistance of the remaining measuring loop from evaluation unit 610 to cable lug 511a, from there back to evaluation unit 610 via screw connection 114a (FIG. 2) and the other frame wiring of the engine. This is, for example, advantageous if the resistance of individual resistance paths 5110 is in the kiloohm range.

In another advantageous specific embodiment (cf. FIG. 5), signal conductor 511 is knitted at least partially in a net-like manner to form a conductive hose. This has the advantage that this netting hose is produced separately from protection or carrier hose 514 and may be pushed over the latter in a later manufacturing step.

The netting mesh of the hose should preferably be knitted from a single, preferably electrically insulated, wire 5112 to be sufficiently close so that the distances of netting knots 5113 among each other are smaller than possible wear points 10a (FIG. 3). The end of the netting hose facing laser spark plug 500 may be secured (i.e., fixed) in the position on protection hose 514 by a metal ring 5111, for example, and connected to ring cable lug 511a. Another shell for fixing or insulating ring 5114, among other components, may surround the system completely or partially.

1-15. (canceled)

16. A covering device for a spark plug shaft of an internal combustion engine, comprising:
a covering element; and
a fastening unit configured to mechanically fasten the covering element to a target system, wherein the fastening unit is further configured to electrically conductively connect at least one electric conductor to at least one of the covering element and the target system.

17. The covering device as recited in claim 16, wherein the fastening unit is configured to connect the at least one electric conductor to at least one of the covering element and the target system with the aid of one of a screw connection or a clamping connection.

18. The covering device as recited in claim 17, wherein the fastening unit has a mechanical coding which cooperates with a corresponding mechanical coding of a contact element of the electric conductor in such a way that an electrically conductive connection is established between the contact element of the electric conductor and the at least one of the covering element and the target system only in the case of a proper mechanical fastening of the contact element to the fastening unit.

19. The covering device as recited in claim 18, wherein the fastening unit has, as the mechanical coding, an elevated eye which protrudes from a base area of the covering element.

20. The covering device as recited in claim 18, wherein the fastening unit has a stud bolt and a nut cooperating with the stud bolt.

21. The covering device as recited in claim 18, wherein the covering element is impermeable to optical radiation of at least one predefined wavelength range.

22. The covering device as recited in claim 18, wherein the covering element is made at least partially of at least one of plastic, metal, and a magnetically conductive material.

23. The covering device as recited in claim 18, further comprising:
at least one identifier configured as a radio frequency identification transponder to wirelessly transmit an identification signal to an evaluation unit which applies a query signal to the identifier.

24. An optical fiber device for a laser spark plug, comprising:
at least one optical fiber element for transmitting optical power to the laser spark plug; and
at least one electric signal conductor for transmitting electrical signals.

25. The optical fiber device as recited in claim 24, wherein an end section of the signal conductor has a contact element configured as a ring cable lug for electrically contacting an object.

26. The optical fiber device as recited in claim 25, wherein the contact element has a mechanical coding which cooperates with a corresponding mechanical coding provided on the object.

27. The optical fiber device as recited in claim 26, wherein the signal conductor is at least sectionally wound around a carrier layer of the optical fiber element.

28. The optical fiber device as recited in claim 27, wherein the signal conductor is formed at least sectionally by resistance paths which (i) are printed on the carrier layer of the optical fiber element and (ii) essentially extend in the longitudinal direction of the optical fiber element.

29. The optical fiber device as recited in claim 27,
wherein the signal conductor is knitted at least partially in a net-like manner to form a conductive hose.

30. An ignition system for an internal combustion engine, comprising:
a laser spark plug including a pumping module for supplying the laser spark plug with pumped radiation;
an optical fiber device for transmitting the pumped radiation from the pumping module to the laser spark plug,
wherein the optical fiber device includes at least one optical fiber element for transmitting optical power to the laser spark plug and at least one electric signal conductor for transmitting electrical signals; and
an evaluation unit configured to: (i) apply a check signal to the at least one signal conductor of the optical fiber device; (ii) evaluate a response signal resulting from the check signal; and (iii) determine an operating state of the signal conductor from the response signal.
